(19) United States
(12) Patent Application Publication
(10) Pub. No.: US 2022/0398624 A1
(43) Pub. Date: Dec. 15, 2022

(54) INFORMATION PROCESSOR AND INFORMATION PROCESSING METHOD

(71) Applicant: TOYOTA JIDOSHA KABUSHIKI KAISHA, Toyota-shi (JP)

(72) Inventors: Naoya OKA, Nagakute-shi (JP); Satoshi KITAMURA, Nagoya-shi (JP); Yusuke SOBUE, Nagoya-shi (JP); Seira NAKADA, Nagoya-shi (JP); Mami MORI, Nagoya-shi (JP); Masato MORISHIMA, Nagoya-shi (JP); Yasuyuki NUNOKAWA, Nagoya-shi (JP)

(73) Assignee: TOYOTA JIDOSHA KABUSHIKI KAISHA, Toyota-shi (JP)

(21) Appl. No.: 17/831,829

(22) Filed: Jun. 3, 2022

(30) Foreign Application Priority Data
Jun. 10, 2021 (JP) 2021-097542

(51) Int. Cl. G06Q 30/02; G06Q 10/02; G06Q 50/30

(52) U.S. Cl. CPC G06Q 30/0239; G06Q 10/02; G06Q 50/30

(57) ABSTRACT

An information processor obtains first data related to movement of a first user, and determines an incentive provided to a plurality of users including the first user, when determining that the users who got together by vehicle received a predetermined service while traveling together, in a predetermined area, based on at least the first data.

### CROSS-REFERENCE TO RELATED APPLICATION

This application claims priority to Japanese Patent Application No. 2021-097542 filed on Jun. 10, 2021, incorporated herein by reference in its entirety.

### BACKGROUND

### 1. Technical Field

The disclosure relates to an information processor and an information processing method.

### 2. Description of Related Art

Services that provide information to users who are traveling are known. In this connection, for example, Japanese Unexamined Patent Application Publication No. 2002-024458 (JP 2002-024458 A) discloses a system that aggregates real-time information on tourist sites into a database, which can be viewed by a mobile terminal possessed by a user.

### SUMMARY

The disclosure provides an information processor that efficiently issues incentives to users who are traveling, and an information processing method.

An information processor according to a first aspect of the disclosure has a controller configured to obtain first data related to movement of a first user, and determine an incentive provided to a plurality of users including the first user, when determining that the users who got together by vehicle received a predetermined service while traveling together, in a predetermined area, based on at least the first data.

An information processing method according to a second aspect of the disclosure includes a step of obtaining first data related to movement of a first user, and a step of determining an incentive provided to a plurality of users including the first user, when determining that the users who got together by vehicle received a predetermined service while traveling together, in a predetermined area, based on at least the first data.

Another aspect of the disclosure is a program that causes a computer to perform the above information processing method, or a computer-readable storage medium that non-transitorily stores the program.

According to the disclosure, it is possible to efficiently issue incentives to traveling users.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view useful for briefly describing a reservation system;

FIG. 2 is a view illustrating the configuration of a server device and a user terminal;

FIG. 3 shows an example of the itinerary generated by a first user;

FIG. 4 shows an example of spot data stored in a storage unit;

FIG. 5 shows an example of reservation data generated by the server device;

FIG. 6 shows an example of track record data stored in the storage unit;

FIG. 7 shows an example of coupon data stored in the storage unit;

FIG. 8 is a flowchart of a first process performed by a controller in a first embodiment;

FIG. 9 is a flowchart of the first process performed by the controller in the first embodiment;

FIG. 10A shows an example of a screen having a list of spots reserved;

FIG. 10B shows an example of a screen having a list of spots reserved;

FIG. 11 is a flowchart of a second process performed by the controller in the first embodiment;

FIG. 12 is a flowchart of a third process performed by the controller in the first embodiment;

FIG. 13 is a view useful for describing the configuration of a server device in a second embodiment;

FIG. 14 is a flowchart of a second process performed by a controller in the second embodiment; and

FIG. 15 shown an example of meet-up plan data in the second embodiment.

### DETAILED DESCRIPTION OF EMBODIMENTS

An information processor according to one aspect of the disclosure has a controller configured to obtain first data related to movement of a first user, and determine an incentive provided to a plurality of users including the user, when determining that the users who got together by vehicle received a predetermined service while traveling together, in a predetermined area, based on at least the first data.

The information processor is a system that provides online services related to traveling, for example. Examples of the services include a service to generate travel plans, a service to make reservations all at once for two or more spots (e.g., an accommodation facility, restaurant, parking lot, etc.) to be visited during a trip, and a service that sells travel products. The controller determines, based on the first data, for example, that two or more users are traveling and acting together after meeting up at a destination. By providing incentives to all group members, who individually headed for the destination and are doing sightseeing after meeting up, as targets, it is possible to encourage more users to use the online services.

The first data may include a meet-up plan for the users, which is generated by an online service that creates a travel plan for the user. Also, the controller may be configured to determine the incentive, under a condition that the first data includes a meet-up plan generated by an online service that creates a travel plan for the user.

The meet-up plan is a plan of, for example, “at what point and at what time a plurality of users will get together (meet up)”. By referring to the meet-up plan generated by the online service, it is possible to determine whether the users meet up and act together (namely, where the users become targets of incentives).

The incentive may be provided with respect to the vehicle used by each of the users. When the users get together at a destination by vehicle, the burden on each user can be reduced by giving an incentive with respect to each vehicle.

The incentive may be a service that is related to parking or car washing and is provided at a predetermined site in the predetermined area. For example, free service (or discount service) for parking or car washing is provided, so that the burden on the user can be reduced.

The controller may be configured to send data representing the determined incentive to an external device corresponding to the predetermined site. The external device may be a device that manages the entry and exist of a parking lot, or a device installed at a site (such as a car wash or a gas station) where car washes can be performed, for example.

The controller may be configured to further obtain second data related to the service received by the users in the predetermined area. The second data may be related to the number of spots used by the users, or the amount of payment at a predetermined spot, for example. By using the second data, it is possible to determine the incentive based on the content of the service received by the users in the predetermined area. The second data may be of any type, provided that the content of the service received by the users can be identified. For example, the second data may be obtained from a device installed in a store, etc., or may be obtained from a mobile terminal possessed by the user.

The controller may be configured to determine that the incentive is provided, when the number of the spots used or the amount of payment at the predetermined spot satisfies a condition. For example, the incentive may be provided when the two or more users in a group activity use a predetermined number of stores or more, or when the users spend a predetermined amount of money or more at a store, or the like.

The controller may be configured to determine a content of the incentive, based on the number of the spots used or the amount of payment at the predetermined spot. For example, the length of time for which the vehicle can be parked for free may be determined, based on the number of the stores used or the amount of payment. The amount of payment may be the sum of the amounts paid by the users.

Some specific embodiments of the disclosure will be described based on the drawings. The hardware configuration, module configuration, functional configuration, etc. described in each embodiment are not intended to limit the technical scope of the disclosure only to the configurations unless particularly stated otherwise.

### First Embodiment

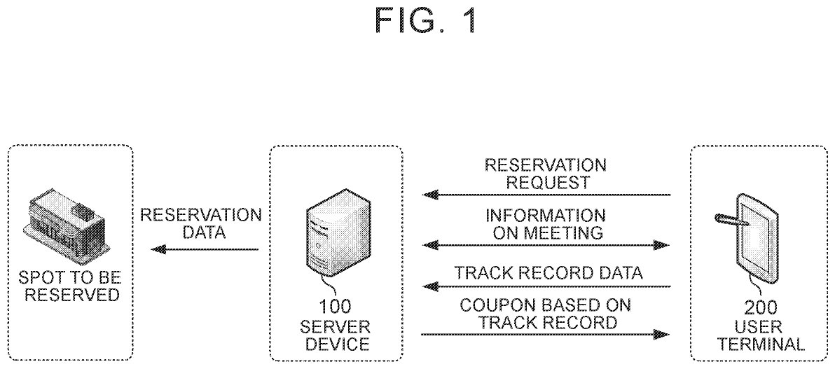

A reservation system according to a first embodiment will be briefly described with reference to FIG. 1. The reservation system of this embodiment includes a server device 100 that makes reservations for two or more spots (e.g., accommodation facilities and restaurants) all at once, and two or more user terminals 200.

The server device 100 generates reservation data to reserve two or more spots registered in advance, based on a request transmitted from a user terminal 200. The server device 100 manages a plurality of spots, and plans provided at the spots, and can reserve the spots and plans, based on requests from users. The user terminal 200 is a computer owned by a user who uses the reservation service. The user can access the server device 100 via the user terminal 200, and request reservations for two or more spots.

In the following description, the user who makes reservations for spots will be called “first user”, and the user who shares activities with the first user at the site will be called “second user”. The first user may be said to be a user who makes a reservation on behalf of two or more users. The second user may be two or more people.

The server device 100 assists the first user and one or more second users to meet up. For example, the server device 100 determines the combination of the first user and the second user who will share activities, generates a guide or directions for each user to meet up with other users at the site, and sends it to each user terminal 200. Also, the server device 100 obtains track record data concerning the use of spots from a plurality of user terminals 200, and issues coupons based on the obtained track record data. A specific method will be described later.

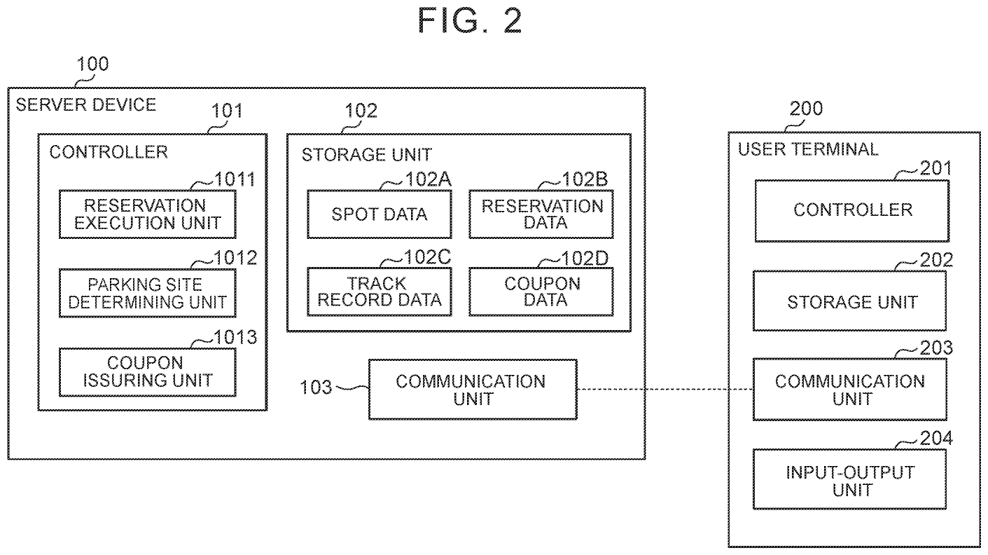

FIG. 2 shows, in more detail, constituent elements of the server device 100 and user terminal 200, which are included in an information processing system according to the embodiment. Initially, the user terminal 200 will be described. The user terminal 200 is a computer, such as a personal computer, smartphone, mobile phone, tablet computer, or personal information terminal, which is used by an individual. The user terminal 200 includes a controller 201, storage unit 202, communication unit 203, and input-output unit 204.

The controller 201 is a computing device that controls operation performed by the user terminal 200. The controller 201 can be realized by an arithmetic processing device such as a central processing unit (CPU). The controller 201 performs the function of accessing and interacting with the server device 100. The function may be implemented by a web browser that runs on the user terminal 200, or by dedicated application software.

The storage unit 202 includes a main storage device and an auxiliary storage device. The main storage device is a memory in which programs executed by the controller 201 and data used by the control programs are developed. The auxiliary storage device is a device in which programs executed by the controller 201 and data used by the control programs are stored. The auxiliary storage device may store programs to be executed by the controller 201 such that the programs are packaged as applications. Also, an operating system for executing these applications may be stored. In operation, a program stored in the auxiliary storage device is loaded into the main storage device and executed by the controller 201, so that a process that will be described below is performed.

The main storage device may include a random access memory (RAM) and a read-only memory (ROM). The auxiliary storage device may include an erasable programmable ROM (EPROM) and a hard disk drive (HDD). Furthermore, the auxiliary storage device may include removable media, i.e., portable storage media.

The communication unit 203 is a wireless communication interface for connecting the user terminal 200 to a network. The communication unit 203 is configured to be able to communicate with the server device 100, via a mobile communication service such as wireless LAN (Local Area Network), 3G, LTE (Long Term Evolution), and 5G. The input-output unit 204 accepts input operation performed by the user, and presents information to the user. In this embodiment, the input-output unit 204 is in the form of a single touch panel display. Namely, the input-output unit 204 consists of a liquid crystal display and its controller, and a touch panel and its controller.

Next, the server device 100 will be described. The server device 100 is a device that makes reservations for spots, based on requests sent from the user terminal 200.

In this embodiment, the server device 100 may be configured to be able to implement a web server for interacting with the user terminal 200. In this case, for example, the user terminal 200 accesses the web server using a browser, so that the user can make a reservation for a spot. The server device 100 may offer services by any means other than the web server. For example, a service that allows interactions using a dedicated application software installed on the user terminal 200 and a predetermined protocol may be implemented in the server device 100.

The server device 100 may be provided by a general-purpose computer. Namely, the server device 100 may be configured as a computer having a processor such as a CPU or graphics processing unit (GPU), a main storage device such as RAM and ROM, and an auxiliary storage device such as EPROM, hard disk drive, or removable medium. The auxiliary storage device stores an operation system (OS), various programs, various tables, etc., and a program stored therein is loaded into a working area of the main storage device and executed, so that each component, etc. is controlled through execution of the program. In this manner, each function that meets a specified purpose can be implemented, as will be described later. However, some or all of the functions may be implemented by hardware circuits such as application specific integrated circuits (ASICs) or field programmable gate arrays (FPGAs).

The controller 101 is a computing device that controls operation performed by the server device 100. The controller 101 can be realized by an arithmetic processing device such as a CPU. The controller 101 has three function modules, i.e., a reservation execution unit 1011, parking site determining unit 1012, and coupon issuing unit 1013. Each of the function modules may be implemented by causing the CPU to execute a stored program.

The reservation execution unit 1011 determines the spots and plans to be used by the user during a trip, based on the results of interaction with the user terminal 200 possessed by the first user, and generates reservation data. In this embodiment, the spots mean facilities used by users. Examples of the spots include accommodation facilities, restaurants, and entertainment facilities, for example. Furthermore, the spots may be facilities such as a parking lot, a car wash, and a gas station, which provide services related to automobiles. Furthermore, the spots may be facilities (experience-type facilities) that provide activities and experiences. This type of facilities may include, for example, facilities where the users can experience particular occupations such as agriculture, sports, cruising, and sightseeing flights.

In this embodiment, the plans identify services provided at each of the spots. When the spot is an accommodation facility, examples of the plans include “single room, one night”, “single room, one night (with breakfast)”, and “double room, one night”. When the spot is a restaurant, examples of the plans include “course meal (lunch)” and “course meal (dinner)”. In addition, the plans may be set in any way, provided that the plans can identify services provided at the individual spots.

The reservation execution unit 1011 determines the combinations of spots to be used by the user during a trip, and plans to be used at the respective spots. Each of the plans thus determined is associated with the date and time at which the spot concerned is used. These items of information will be called “itinerary”. The reservation execution unit 1011 generates data (reservation data) for making reservations for the spots, according to the itinerary generated, and sends the data to external devices corresponding to the respective spots. In this manner, the user can make reservations all at once for the facilities, etc. to be used during the trip.

The parking site determining unit 1012 determines a site (which will be called “parking site”) at which the first user and the second user will park vehicles. The parking site is a spot at which the first user and the second user meet up, and also a spot at which each user parks his/her vehicle during sightseeing. When the first user generates the itinerary, the parking site determining unit 1012 determines a spot in the itinerary where the vehicles can be parked.

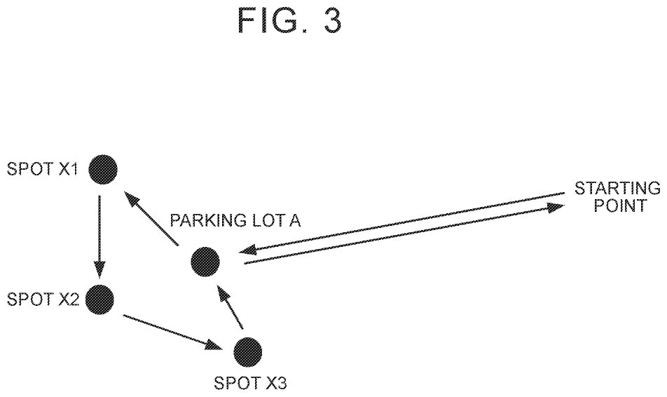

FIG. 3 is an example of the itinerary generated by the first user. In this example, the user parks his/her vehicle in a parking lot A, visits several sightseeing spots, and then returns to the starting point. By deciding on the parking site, it is possible to have two or more users individually heading for the destination meet at the site and act as a group.

When two or more users who meet up use a certain spot together, the coupon issuing unit 1013 issues an electronic coupon that can be used by each user. In this embodiment, the coupon issuing unit 1013 issues coupons related to vehicles (e.g., a free parking ticket that can be used at a parking lot) to the two or more users, based on the actual use of the spot (e.g., a store) by the users who have gathered, in a given area. Then, the coupon issuing unit 1013 sends the coupons to the user terminals 200 corresponding to the first user and the second user. The electronic coupon may be data that can be transmitted between terminals, or those such as a bar code and a two-dimensional code, which can be optically read. The electronic coupon may also be image data.

In the example of FIG. 3, the parking service at the parking lot A can be provided, based on the actual use of the spots X1 to X3 by the users. This makes it easy for the users to park the vehicles and do sightseeing in a group in a target area. In order to confirm that a user used a spot as reserved, the coupon issuing unit 1013 may communicate with the user terminal 200 possessed by the user who has visited the spot, and obtain data on the actual use of the spot (which will be described later as track record data 102C).

The storage unit 102 includes a main storage device and an auxiliary storage device. The main storage device is a memory where programs executed by the controller 101 and data used by the control programs are developed. The auxiliary storage device is a device in which programs executed by the controller 101 and data used by the control programs are stored.

The storage unit 102 also stores spot data 102A, reservation data 102B, track record data 102C, and coupon data 102D.

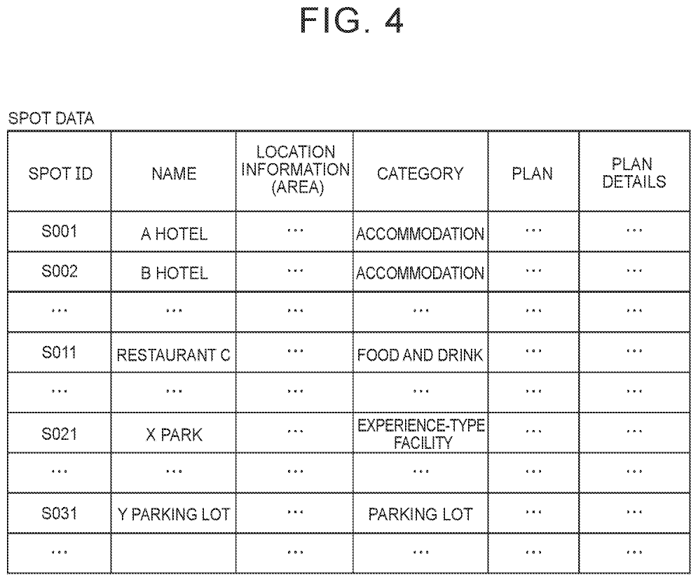

The spot data 102A is data that defines a plurality of spots as reservation targets. FIG. 4 is an example of the spot data 102A. The spot data 102A includes, for example, the identifiers of the spots, names of the spots, location information (areas where the spots exist), information related to the category, services (plans) provided at the spots, etc.

When there is a limitation to the resource (e.g., the number of rooms or seats) for the service that can be provided at each spot, it may be necessary to check availability before accepting a reservation. To deal with this situation, the spot data 102A may also include data used for determining whether a reservation can be made. One example of the data is a reference to a reservation book. By accessing the reservation book via the data, the reservation execution unit 1011 can present the possibility of making the reservation to the user. The reservation book may be possessed by the server device 100 or may be possessed by an external device corresponding to each spot.

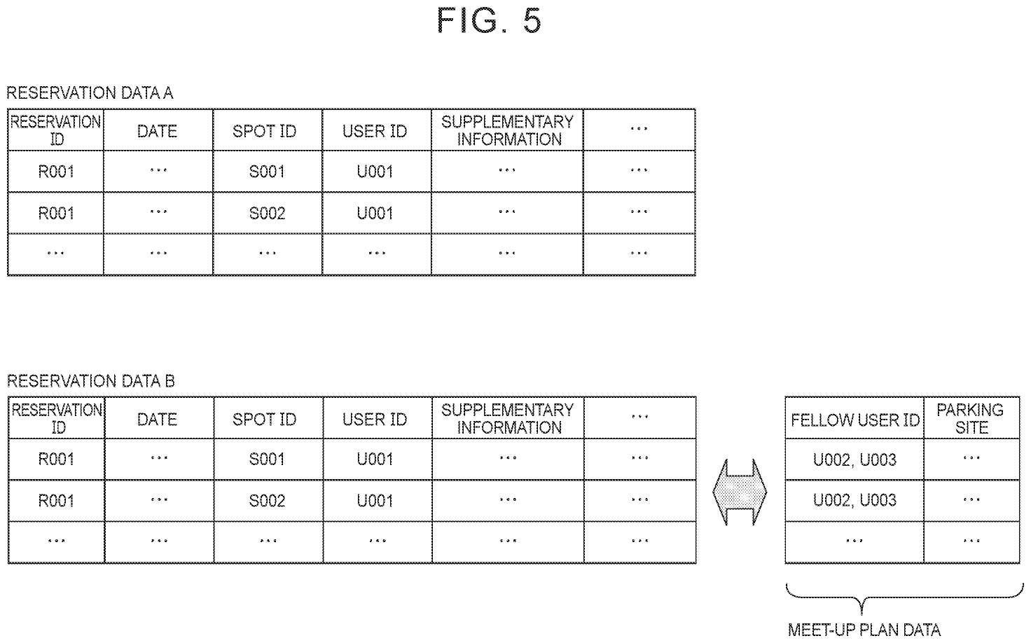

The reservation data 102B is generated by the reservation execution unit 1011. The generated reservation data is temporarily stored in the storage unit 102 until it is sent to an external device. “RESERVATION DATA A” in FIG. 5 is an example of the reservation data 102B. The reservation data 102B includes information that identifies the combination of reservation, date, spot (that may include a plan), and user, and supplementary information. The supplementary information is information that is required when applying for a reservation at a spot. Examples of the supplementary information include the reservation time (arrival time, check-in time), the number of users, the age and gender of each user, and contact information of the user.

The track record data 102C is used for checking if the user who reserved a spot actually used the spot. In the first embodiment, when the user used the spot reserved, the user terminal 200 sends track record data indicating the use of the spot to the server device 100. For example, when the user arrives at a spot, the user terminal 200 reads data that proves that the user has received service as reserved, and sends the data to the server device 100. The data may be in the form of a two-dimensional bar code posted in a store, for example. This operation may be performed by the first user on behalf of the group, or by all members of the group. Also, when the user terminal 200 can use electronic payment services, data indicating the history of electronic payment is sent from the user terminal 200 to the server device 100, so that the server device 100 can check the amount paid by the user at the corresponding spot. The server device 100 may calculate the sum of the amounts paid by all members of the group, based on data obtained from their user terminals 200. The track record data corresponds to the second data according to the disclosure.

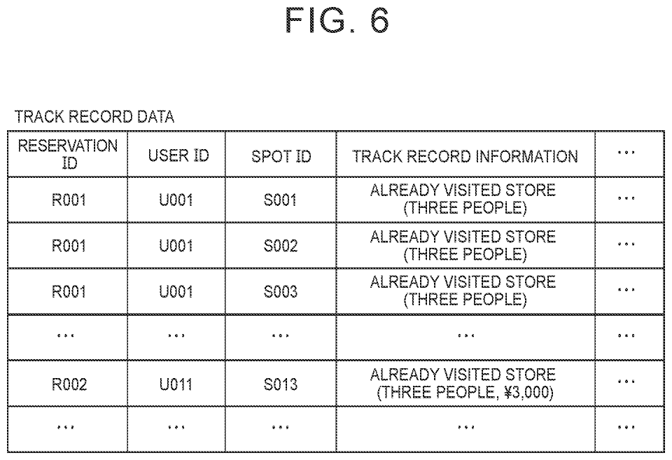

FIG. 6 is an example of the track record data 102C in the first embodiment. The track record data 102C includes, for example, the identifiers of the reservations, identifiers of the users, identifiers of the spots, information related to the track record (e.g., whether or not a visit was made, the number of visitors, the amount of payment, etc.).

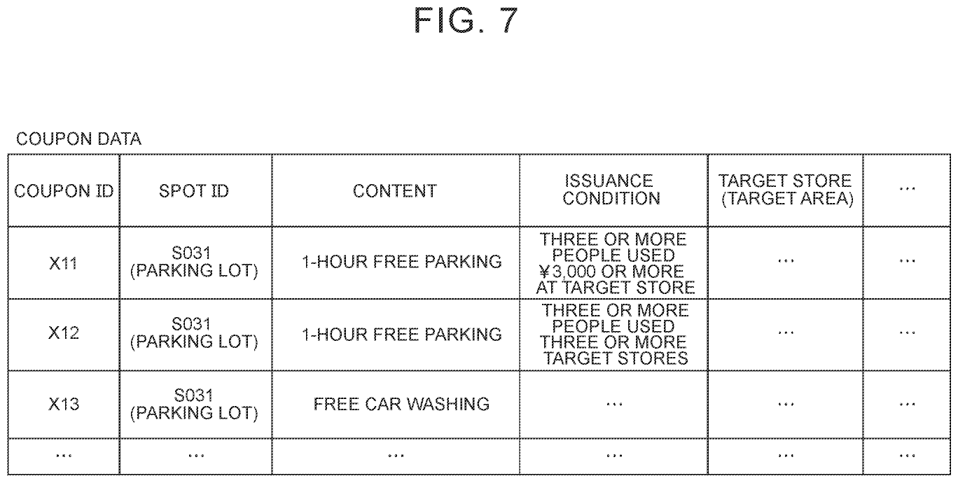

The coupon data 102D is data that defines incentives (typically, electronic coupons) provided to the users. FIG. 7 is an example of the coupon data 102D in the first embodiment. The coupon data 102D includes, for example, the identifiers of the spots, identifiers of the coupons, and data related to the contents of the coupons.

In the first embodiment, the coupons are related to parking services and car washing services provided at the parking site. The coupon may be a free coupon or a discount coupon. While the services are provided at the parking lot in this example, the site at which the services are provided may be a gas station or a car wash. Also, the services provided via coupons may be free (or discounted) services such as fueling and interior cleaning.

The coupon data 102D includes data (issuance conditions) indicating conditions under which the coupons are issued. Examples of the conditions for issuing the coupons may include, for example, “three or more people spend 3,000 yen or more at a target store”, and “three or more people use three or more target stores”. The coupon data 102D may include data for specifying target stores (spots). The data may include the identifiers of the spots as targets, and the identifiers of the areas, for example. The coupon data 102D may also include electronic data transmitted to the user terminal 200, or data for generating the electronic data.

Each item of the above data may be constructed by managing data stored in the storage unit, according to a program of a database management system (DBMS) executed by a processor. In this case, each data may be a relational database, for example.

The communication unit 103 is a communication interface for connecting the server device 100 to a network. The communication unit 103 includes, for example, a network interface board, or a wireless communication interface for wireless communication.

The configuration shown in FIG. 2 is one example, and all or some of the functions illustrated in FIG. 2 may be implemented using specially designed circuits. Also, a combination of main storage device and auxiliary storage device other than those illustrated in the figures may be used to store and execute the programs.

Next, processing performed by the server device 100 will be described. The server device 100 performs three processes as follows: (1) a process (first process) of making a reservation for a spot, based on a request from the first user, (2) a process (second process) of associating the first user and the second user who share activities with each other, and assisting the first and second users to meet up with each other, and (3) a process (third process) of issuing electronic coupons to the users who used service after meeting up.

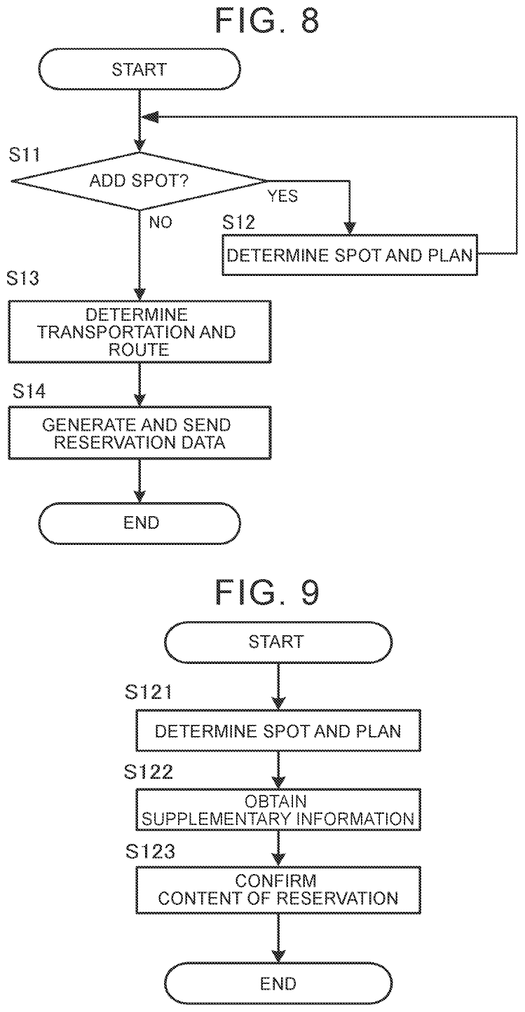

FIG. 8 is a flowchart illustrating the first process performed by the server device 100. The process of the flowchart shown in FIG. 8 is carried out at the time when the first user logs in to the reservation service provided by the server device 100, for example. It is assumed that the server device 100 has completed the identification of the user at the time when the process is started.

In steps S11 to S13, the reservation execution unit 1011 creates the itinerary.

The itinerary is created by adding one or more spots, and then determining the means of transportation. In step S11, the reservation execution unit 1011 determines whether to add a spot. In this step, the reservation execution unit 1011 obtains, from the user, a request regarding a reservation for an accommodation facility, restaurant, entertainment facility, experience-type facility, parking lot, or the like. When an affirmative decision (YES) is obtained in this step, the control proceeds to step S12. When a negative decision (NO) is obtained in this step, the control proceeds to step S13.

In step S12, the reservation execution unit 1011 determines the spot and plan to be used by the user. A process performed by the reservation execution unit 1011 in step S12 will be described in more detail, with reference to FIG. 9.

Initially, in step S121, the spot and plan to be used are determined. For example, where the spot added is an accommodation facility, the reservation execution unit 1011 determines the accommodation facility in step S12, based on the selection of the user. For example, the reservation execution unit 1011 provides a search screen for accommodation facilities, and allows the user to search available accommodation facilities. Furthermore, the reservation execution unit 1011 provides a list of plans, according to a search condition(s) entered via the screen, and allows the user to select a plan from the list. The plan that can be reserved may be determined by referring to the spot data 102A and the reservation book, for example.

Then, in step S122, supplementary information related to the use of the spot is obtained. When the spot is an accommodation facility, date and time information (in this example, the check-in date and check-in time), the number of guests, the age and gender of each guest, etc. are obtained as the supplementary information.

In this example, the spot is an accommodation facility. When the spot is a facility other than accommodation, such as a restaurant, entertainment facility, experience-type facility, or parking lot, supplementary information that matches the spot may be obtained in step S12. For example, when the spot is a parking lot, information about the vehicle and the number of vehicles may become supplementary information. When the spot is a parking lot, parking slots sufficient to allow all of the users who share activities to park their vehicles may be reserved. In step S123, the content of the reservation is confirmed based on the user's input.

Returning to FIG. 8, description will be continued. When addition of the spot is completed, the reservation execution unit 1011 returns to step S11, and determines whether another spot needs to be added. When another spot is to be added, step S11 and step S12 are repeatedly executed.

The flowchart of FIG. 8 shows an example of adding two or more spots sequentially. However, before starting to create the itinerary, the user may be asked to specify conditions, and the combinations of spots and plans that match the specified conditions may be automatically extracted and presented. The conditions may include, for example, the area to be traveled, departure point, departure date and time, spots which the user wishes to visit, categories of the spots which the user wishes to visit, return date and time, etc. In this manner, a recommended itinerary can be automatically generated. The itinerary thus generated may be editable by the user. For example, the user may add, delete and replace one or more spots, and replace one or more plans, for example.

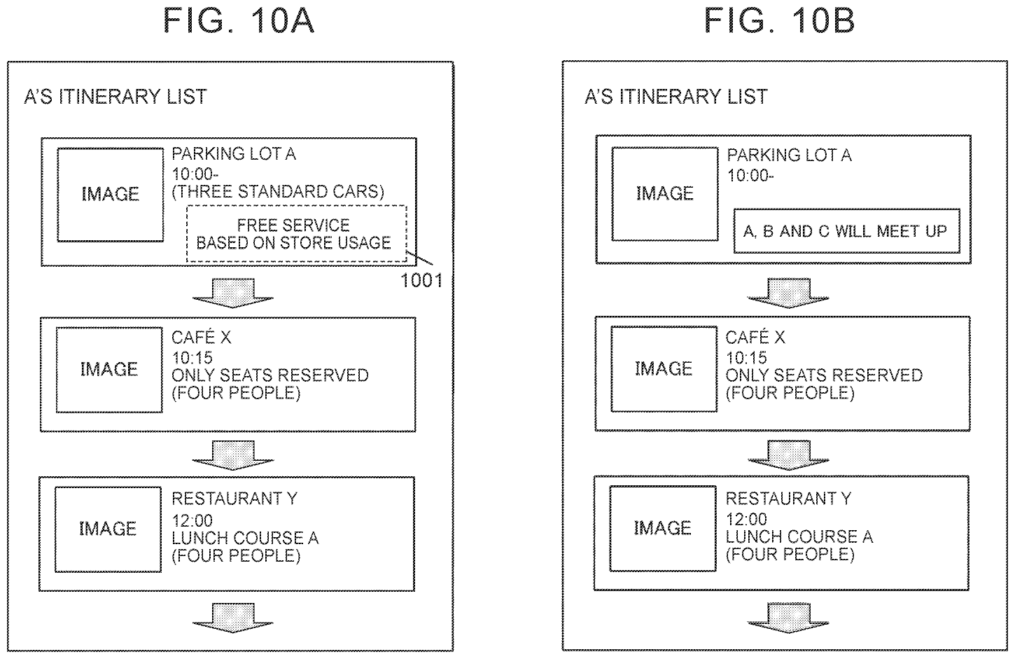

FIG. 10A is an example of a screen having a list of two or more spots added. When the spots thus added include a spot where an incentive is provided (e.g., a parking lot at which a free parking service is provided), this fact may be displayed (reference sign 1001).

In step S13, the reservation execution unit 1011 determines a transportation to be used and its route. The transportations available to the user include a private car, rental car, public transportation, and so forth. In this step, the reservation execution unit 1011 determines the transportation to be used and its details, via a user interface screen, and collects information for reserving the transportation as needed. When the user uses a transportation that requires reservation, the reservation execution unit 1011 may check the availability in this step, through communication with an external device in charge of the transportation. The external device may provide reservation service for trains, airplanes, taxicabs, rental cars, and so forth. When a private car is used as the transportation, the reservation execution unit 1011 may perform a route search and determine a traveling route in this step. For example, when there are two or more spots reserved, the reservation execution unit 1011 may search for pathways connecting the spots, and determine a route for the entire itinerary. For instance, in the example of FIG. 3, a traveling route that consists of six trips may be determined.

In step S14, the reservation execution unit 1011 generates data (reservation data) for reserving the spots (and transportation as needed) to be used by the user. In this step, the reservation data as illustrated in FIG. 5 as “RESERVATION DATA A” is generated, and sent to an external device or devices respectively corresponding to one or more spots (or transportation) used by the user.

Through the process as described above, the server device 100 can accept reservations for two or more spots, from the user, and determine the itinerary.

Next, the process (second process) of assisting two or more users to meet up will be described. In the second process, the server device 100 associates the first user with the second user, and determines a parking site where the first and second users meet up, based on a request from the second user.

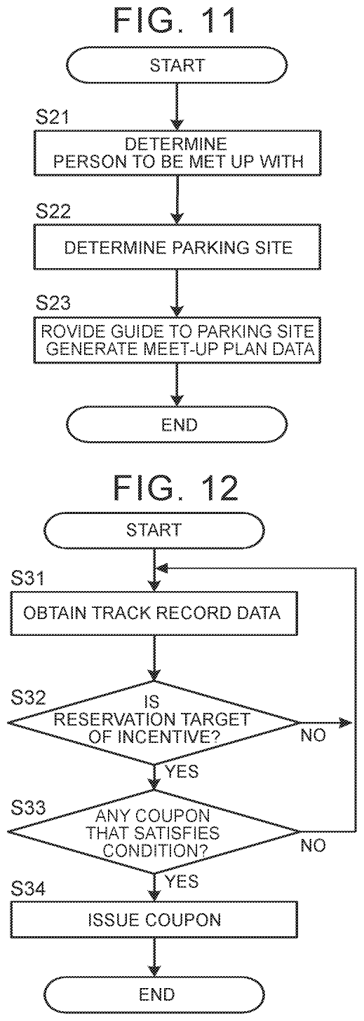

FIG. 11 is a flowchart illustrating the second process performed by the server device 100. The process of the flowchart shown in FIG. 11 is carried out at the time when the second user logs in to the reservation service provided by the server device 100, for example. At the time when the process is started, it is assumed that the server device 100 has completed the identification of the user.

Initially, in step S21, the server device 100 determines the first user with whom the second user will meet up. The user to be met up with may be designated by entering the identifier of the first user, or by entering an identifier corresponding to the itinerary generated by the first user.

Then, in step S22, the server device 100 determines the parking site. As described above, the parking site is a site where two or more users can get together by vehicle. The parking site is preferably a spot where the vehicle can be parked for a long time, for example, a pay-by-the-hour parking lot. For example, when a parking lot is included in the itinerary generated by the first user, the parking site determining unit 1012 determines the parking lot as the parking site. There may be two or more parking sites in the itinerary. For example, when the itinerary is a one-night two-day trip, a parking site used on the first day and a parking site used on the second day may be individually determined. In this step, the meet-up time may also be determined.

Then, in step S23, a guide to the parking site determined is provided. In this step, data including the determined parking site and the meet-up time is sent to the user terminals 200 corresponding to the first user and the second user, respectively. In this manner, each user can obtain information required to meet up with each other. At this time, the parking site determining unit 1012 may generate a route from the starting point of each user to the parking site, and present the route to the user. FIG. 10B is an example of a screen that informs the user of the parking site determined and the meet-up date and time. On the screen, the itinerary generated by the first user may be presented at the same time.

Furthermore, in step S23, the server device 100 generates data on a meet-up plan for the users, and associates the data with the reservation data. The data on the meet-up plan for the users will be called “meet-up plan data”. The meet-up plan data includes the identifier of the second user (that may be two or more) who meets up with the first user, the identifier of the parking site, etc. “RESERVATION DATA B” in FIG. 5 is an example in which the reservation data generated by the first user is associated with the meet-up plan data. With both types of data thus associated with each other and stored, the identifiers of the users who travel together and the parking site can be obtained, with respect to any given reservation. The reservation data associated with the meet-up plan data corresponds to the first data according to the disclosure.

Next, the process (the third process) in which the server device 100 issues electronic coupons will be described. FIG. 12 is a flowchart of the process in which the server device 100 issues electronic coupons to the users who meet up at the site. The process illustrated in FIG. 12 is executed by the coupon issuing unit 1013, at the time when the user terminal 200 sends track record data.

Initially, in step S31, the coupon issuing unit 1013 obtains the track record data sent from the user terminal 200. In this embodiment, when the user visits a spot that has been reserved, the user terminal 200 sends data indicating the actual visit to the server device 100. The data includes the identifier of the reservation, the identifier of the spot visited, the number of people using the spot, the amount of money spent, etc. While the track record data is received from the user terminal 200 possessed by the first user, for example, it may be received from all of the user terminals 200 corresponding to the two or more users who travel and act together. In this manner, the track record data shown in FIG. 6 is accumulated in the server device 100.

Then, in step S32, the coupon issuing unit 1013 determines whether the reservation indicated by the track record data is a target of an incentive. In this step, an affirmative decision (YES) is obtained when the reservation indicated by the track record data is associated with the meet-up plan data. In this case, the coupon issuing unit 1013 can determine that the first user and the second user, who travel together, visited the reserved spot. When an affirmative decision (YES) is obtained in step S32, the control proceeds to step S33. When a negative decision (NO) is obtained in step S32, the control returns to step S31.

Then, in step S33, the coupon issuing unit 1013 determines whether there is a coupon that satisfies an issuance condition or conditions. The coupon issuing unit 1013 can determine whether the coupon can be issued, by comparing the issuance condition defined in the coupon data 102D with the accumulated track record data, for example. When there is any coupon having an issuance condition that is satisfied by the number of visitors, the number of spots visited, the amount of money spent, or the like, for example, an affirmative decision (YES) is obtained in step S33. When there is any coupon that can be issued, the control proceeds to step S34. When there is no coupon that can be issued, the control returns to step S31.

In step S34, the coupon issuing unit 1013 sends electronic data corresponding to the coupon to be issued, to the corresponding user terminals 200. More specifically, the coupon issuing unit 1013 specifies the users (the first user and the second user) concerned with the reservation, by referring to the meet-up plan data associated with the target reservation, and sends the electronic data defined by the coupon data 102D, to the user terminal 200 associated with each user. In this manner, all of the users who travel along with the first user can obtain incentives such as free parking coupons.

The electronic coupon may be presented at the exist of a parking lot, for example, so that the user can receive a free or discounted service. When the electronic coupon is concerned with car washing, cleaning, or the like, the electronic coupon may be sent from the user terminal 200 to a device corresponding to the spot where the vehicle is parked (e.g., a device that manages the parking lot). Thus, a parking lot attendant can start washing or cleaning the vehicle, for example.

As described above, in the first embodiment, when the first user makes a reservation for a spot at a travel destination, and uses the spot along with the second user who met up with the first user at the site, vehicle-related incentives are offered to all of the users. Although the second user does not make any reservation, he/she can obtain a coupon by being registered as traveling with the first user. This makes it possible to encourage more users to use the reservation service.

### First Modified Example of the First Embodiment

While the user terminal 200 sends the track record data indicating that the user used a spot in the first embodiment, a device (store terminal) located at each spot may send the track record data. For example, when the user arrives at a spot, the user may declare that the visit is based on a reservation, and a store attendant who receives the declaration may send track record data to the server device 100 via the store terminal.

### Second Modified Example of the First Embodiment

While it is mandatory for the first user to make a reservation for a spot in the first embodiment, the first user is not necessarily required to make a reservation for a spot. For example, instead of generating reservation data, the user may be asked to register data (intention data) on his/her intention to use a target spot in advance, and a coupon may be offered when the use of the spot that conforms with the registered content can be confirmed. The intention data may be provided in a format similar to that of the reservation data 102B.

### Second Embodiment

In the first embodiment, the first user makes reservations for two or more spots. On the other hand, in the second embodiment, the user is not required to make reservations for spots, or make advance registration regarding the intention to use spots.

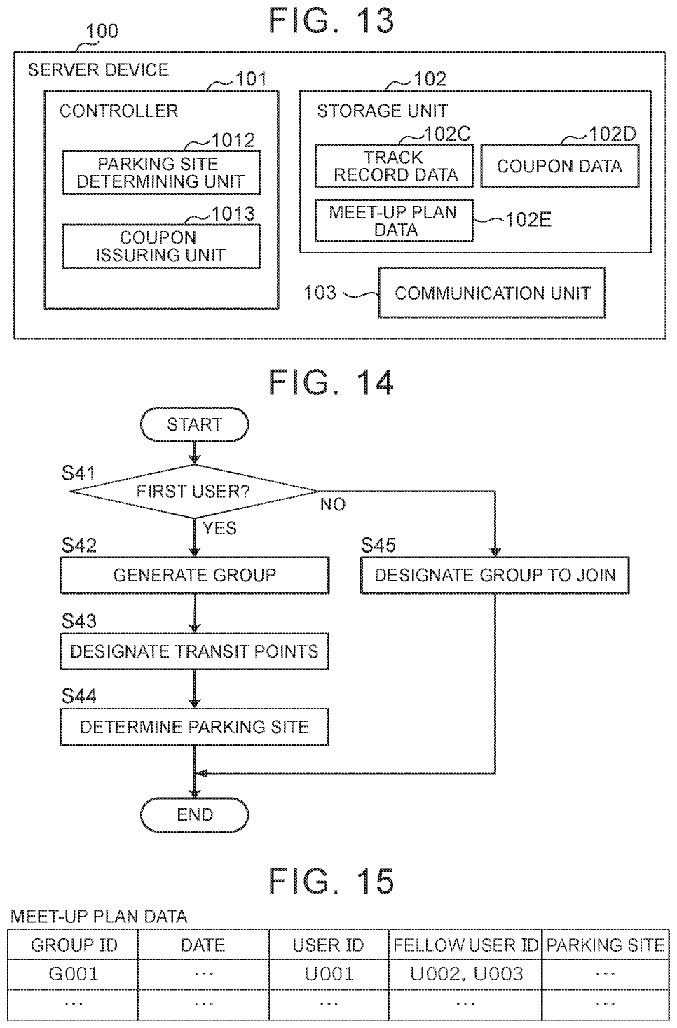

FIG. 13 shows in detail constituent elements of the server device 100 in the second embodiment. The second embodiment is different from the first embodiment in that the server device 100 (the controller 101) does not have the reservation execution unit 1011, and that the storage unit 102 does not store the spot data 102A and the reservation data 102B. The second embodiment is also different from the first embodiment in that the server device 100 does not perform the first process.

FIG. 14 is a flowchart of the second process in the second embodiment. In this embodiment, the first user generates a group and determines a parking site, and the second user joins the group generated.

Initially, in step S41, the controller 101 determines whether the user who accesses the server device 100 is the first user or the second user. When the user is the first user, the control proceeds to step S42. When the user is the second user, the control proceeds to step S45.

In step S42, a new group is generated. In this step, an identifier (group ID) for uniquely identifying the group may be assigned to the group. Then, in step S43, the first user is asked to designate one or more transit points to be passed during a trip. The transit points include at least a parking lot, or the like, that can be used as a meet-up point. Then, in step S44, one of the designated transit points is determined as the parking site.

In step S45, the second user is asked to designate which of the already generated groups the user is going to join. The group may be designated by entering the group ID given in step S42, for example.

In the second embodiment, the combination of the first user and the second user and the parking site are generated through the above process. Since no reservation data is stored in the second embodiment, the meet-up plan data is stored alone in the storage unit 102. FIG. 15 shows one example of the meet-up plan data 102E in this embodiment.

In the third process of the second embodiment, when track record data that meets a requirement is generated, a corresponding coupon is automatically issued. In the second embodiment, the reservation ID is not included in the track record data sent from the user terminal 200. Instead, in the third process (step S32) of the second embodiment, the meet-up plan data is searched, using the user ID indicated in the track record data as a key. Thus, the controller 101 can determine that the user who sent the track record data meets and travels along with two or more users. The other steps of the third process are similar to those of the first embodiment.

As described above, according to the second embodiment, it is possible to issue incentives, without requiring the user to reserve spots in advance.

### Modified Examples

The above embodiments are mere examples, and the disclosure may be embodied with changes as needed, without departing from its principle. For example, the processes and means described in the disclosure may be freely combined and implemented, unless any technical inconsistency arises.

The process described as being performed by a single device may be shared and performed by two or more devices. Alternatively, the processes described as being performed by different devices may be performed by a single device. In a computer system, the type of hardware configuration (server configuration) that implements each function can be flexibly changed.

The disclosure can be realized by supplying a computer program installed with the functions described in the above embodiments, to a computer, and causing one or more processors of the computer to read and execute the program. Such a computer program may be provided to the computer by a non-transitory computer-readable storage medium that can be connected to a system bus of the computer, or may be provided to the computer via a network. The non-transitory computer-readable storage media include, for example, any type of disk such as a magnetic disk (floppy disk (registered trademark), hard disk drive (HDD), etc.), and an optical disk (CD-ROM, DVD, Blu-ray disk, etc.), read-only memory (ROM), random access memory (RAM), erasable programmable read-only memory (EPROM), electrically erasable and programmable read-only memory (EEPROM), magnetic card, flash memory, optical card, and any type of medium suitable for storing electronic instructions.

What is claimed is:

1. An information processor comprising a controller, the controller being configured to:
obtain first data related to movement of a first user; and
determine an incentive provided to a plurality of users including the first user, when determining that the users who got together by vehicle received a predetermined service while traveling together, in a predetermined area, based on at least the first data.

2. The information processor according to claim 1, wherein the first data includes a meet-up plan for the users, the meet-up plan being generated by an online service that creates a travel plan for the first user.

3. The information processor according to claim 1, wherein the controller is configured to determine the incentive, under a condition that the first data includes a meet-up plan generated by an online service that creates a travel plan for the first user.

4. The information processor according to claim 1, wherein the incentive is provided with respect to the vehicle used by each of the users.

5. The information processor according to claim 4, wherein the incentive is a service that is related to parking or car washing and is provided at a predetermined site in the predetermined area.

6. The information processor according to claim 5, wherein the controller is configured to send data representing the determined incentive to an external device corresponding to the predetermined site.

7. The information processor according to claim 1, wherein the controller is configured to further obtain second data related to the predetermined service received by the users in the predetermined area.

8. The information processor according to claim 7, wherein the incentive is provided while the first user is receiving the predetermined service.

9. The information processor according to claim 7, wherein the second data further includes data related to the number of spots used by the users, or an amount of payment at a predetermined spot.

10. The information processor according to claim 9, wherein the controller is configured to determine that the incentive is provided, when the number of the spots used or the amount of payment at the predetermined spot satisfies a condition.

11. The information processor according to claim 9, wherein the controller is configured to determine a content of the incentive, based on the number of the spots used or the amount of payment at the predetermined spot.

12. The information processor according to claim 9, wherein the amount of payment is a sum of amounts of money paid by the users at the predetermined spot.

13. An information processing method, comprising:
obtaining first data related to movement of a first user; and
determining an incentive provided to a plurality of users including the first user, when determining that the users who got together by vehicle received a predetermined service while traveling together, in a predetermined area, based on at least the first data.

14. The information processing method according to claim 13, wherein the first data includes a meet-up plan for the users, the meet-up plan being generated by an online service that creates a travel plan for the first user.

15. The information processing method according to claim 13, wherein the incentive is determined, under a condition that the first data includes a meet-up plan generated by an online service that creates a travel plan for the first user.

16. The information processing method according to claim 13, wherein the incentive is provided with respect to the vehicle used by each of the users.

17. The information processing method according to claim 16, wherein the incentive is a service that is related to parking or car washing and is provided at a predetermined site in the predetermined area.

18. The information processing method according to claim 17, further comprising sending data representing the determined incentive to an external device corresponding to the predetermined site.

19. The information processing method according to claim 13, further comprising obtaining second data related to the predetermined service received by the users in the predetermined area.

20. The information processing method according to claim 19, wherein the second data further includes data related to the number of spots used by the users, or an amount of payment at a predetermined spot.
